(19) United States
(12) Patent Application Publication
(10) Pub. No.: US 2023/0065441 A1
(43) Pub. Date: Mar. 2, 2023

(54) KIOSK MOUNTING APPARATUS WITH AN EMBEDDED PAYMENT MODULE, AND APPLICATIONS THEREOF

(71) Applicant: Infinite Peripherals, Inc., Irvine, CA (US)

(72) Inventors: Jeffrey Lee Scott, Irvine, CA (US); John Broderick, Corona, CA (US); John Vargas, Downey, CA (US)

(21) Appl. No.: 17/465,331

(22) Filed: Sep. 2, 2021

(51) Int. Cl. G06Q 20/18; G06Q 20/20; G06Q 20/32; G06F 1/20

(52) U.S. Cl. CPC G06Q 20/18; G06Q 20/204; G06Q 20/3278; G06Q 20/208; G06F 1/20

(57) ABSTRACT

In an embodiment, a kiosk mounting apparatus includes a chassis, payment module, and enclosure. The chassis is configured to mount a tablet computing device. The tablet computing device includes a touch screen display and is configured to execute an interactive application. The payment module is mounted to the chassis and is configured to be communicatively coupled to the tablet computing device. The payment module is configured to detect payment data specifying an account from a user's payment device. The payment module is configured to encrypt the payment data and to communicate the encrypted payment information to the tablet computing device for processing by a payment gateway. The enclosure is mounted to the chassis and has an opening for the touch screen display. The enclosure encloses the payment module. By enclosing the payment module, the kiosk mounting apparatus encapsulates the payment module into the kiosk.

### BACKGROUND

### Field

This field is generally related to scanning devices.

### Related Art

A kiosk computing device is a computer terminal with specialized hardware and software that provides access to information and applications for communication, commerce, entertainment, or education. They are built into a small structure in a public area and are used for providing and collecting information. Examples include communication and videoconferencing kiosks, financial services kiosks (e.g., Automated Teller Machines), photobook kiosks, Internet kiosks, ticketing kiosks, restaurant kiosks, visitor management and security kiosks, building directory and wayfinding kiosks, hospital and medical clinic registration kiosks, self-checkout kiosks, credit card entry kiosks, and information kiosks.

Some kiosk computing devices include a tablet computing device and a mounting apparatus. Tablet computing device is a mobile device, typically with a mobile operating system and touchscreen display processing circuitry, and a rechargeable battery in a single, thin and flat package. Typically, the touchscreen display is operated by gestures executed by finger or digital pen (stylus), instead of the mouse, touchpad, and keyboard of larger computers. Examples of tablet computing devices include the IPAD device, available from Apple Inc. of Cupertino, Calif., and the GALAXY devices, available from Samsung Group of Seoul, South Korea.

To incorporate a tablet computing device into a kiosk, a mounting apparatus may be used. The mounting apparatus may provide a housing that surrounds the tablet computing device and enables the tablet computing device to be positioned at a height and orientation that is convenient for a user of the kiosk to use to make selections and view information. The mounting apparatus may be configured to sit on the floor, to sit on a tabletop, to mount to a wall, or to be suspended from the ceiling.

Kiosk computing devices sometimes serve as point of sale devices. To accept payment, a tablet computing devices typically do not have integrated payment modules that can read credit cards or near-field payments. To accept payments using a tablet, merchants sometimes use an external device such as the SQUARE READER available from Square, Inc. of San Francisco, Calif. These devices are external and may connect to the tablet using, for example, a USB port on the tablet, either directly or through a cable. Having these devices attached in this way may not be aesthetically pleasing. Also, they may be bulky and may not be durable.

To address these issues, improved kiosk mounting devices are needed.

### BRIEF SUMMARY

In an embodiment, a kiosk mounting apparatus includes a chassis, payment module, and enclosure. The chassis is configured to mount a tablet computing device. The tablet computing device includes a touch screen display and is configured to execute an interactive application. The payment module is mounted to the chassis and is configured to be communicatively coupled to the tablet computing device. The payment module is configured to detect payment data specifying an account from a user's payment device. The payment module is configured to encrypt the payment data and to communicate the encrypted payment information to the tablet computing device for processing by a payment gateway. The enclosure is mounted to the chassis and has an opening for the touch screen display. The enclosure encloses the payment module. By enclosing the payment module, the kiosk mounting apparatus encapsulates the payment module into the kiosk.

System, device, and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 illustrates a kiosk with a tablet computing device and a mounting apparatus having an integrated payment device, according to embodiments.

FIGS. 2A-D illustrate the kiosk from different perspectives.

FIGS. 2E-F illustrate cutaway perspectives of the kiosk.

FIG. 2G illustrates kiosk from a cutaway rear view.

FIG. 3 is a circuit diagram of the kiosk.

FIGS. 4A-B illustrate different ways for the kiosk to be mounted.

FIGS. 5A-D illustrate different ways of attaching graphics to the mounting apparatus

FIG. 6 illustrates a system diagram of the tablet computing device incorporated into the kiosk.

The drawing in which an element first appears is typically indicated by the leftmost digit or digits in the corresponding reference number. In the drawings, like reference numbers may indicate identical or functionally similar elements. The drawings are illustrative and may not be to scale.

### DETAILED DESCRIPTION

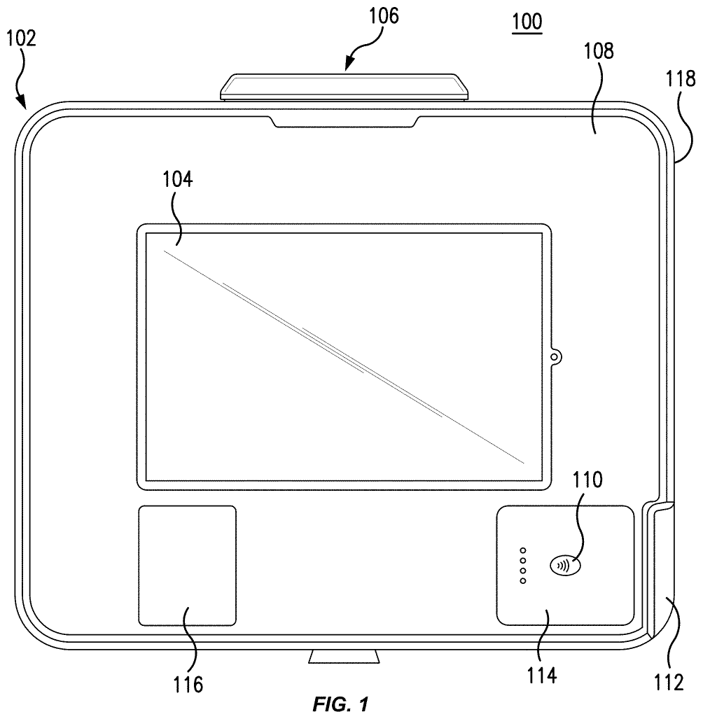

FIG. 1 illustrates a kiosk 100 with a tablet computing device and a mounting apparatus having an integrated payment device, according to embodiments.

Kiosk 100 is a computer terminal with specialized hardware and software that provides access to information and applications. It may be built into a public area for use in various applications for communication, commerce, entertainment, or education. Kiosk 100 includes a tablet computing device 104 and a kiosk mounting apparatus 102.

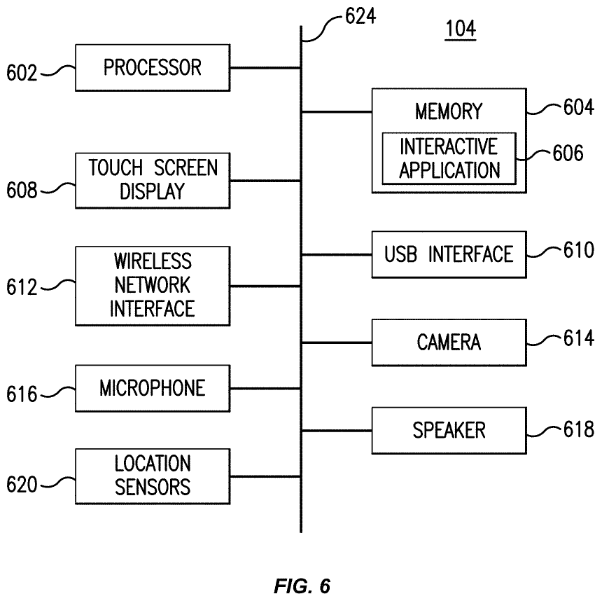

Tablet computing device 104 is a tablet computer. It has a touch screen display four input and output of data. It is configured to execute an interactive application. More detail on tablet computing device 104 is described below with respect to FIG. 6.

Kiosk mounting apparatus 102 contains tablet computing device 104, enabling tablet computing device 104 to be used as a kiosk. Kiosk mounting apparatus 102 provides an enclosure that secures tablet computing device 104 and enables it to be mounted. Also, kiosk mounting apparatus 102 includes electronic devices that expand the capabilities of tablet computing device 104 to provide the particular functions needed of kiosk 100. Among the electronic devices are a payment module 114 and RFID reader 116.

Payment module 114 is included within kiosk mounting apparatus 102 and configured to be communicatively coupled to tablet computing device 104. Payment module 114 is configured to detect payment data specifying an account from a user's payment device, encrypt the payment data, and communicate the encrypted payment data to the tablet computing device for processing by a payment gateway.

Payment module 114 may collect, encrypt, and communicate the payment data in various ways. In one example operation, the payment data may be encoded on a magnetic strip on a user's credit card. The payment data may be, for example, a 16-digit personal account number. Payment module 114 has a card insert 112 and, when the user inserts her credit card into card insert 112, payment module 114 collects the payment data from the card. Payment module 114 has a private key installed that it uses to encrypt the payment data. Once encrypted, payment module 114 transmits the encrypted payment data for processing by a payment gateway.

In another example operation, the payment data may be collected from an EMV (“Europay, Mastercard, and Visa”) card chip. In that example, the user inserts her credit card into card insert 112, and payment module 114 excites the EMV chip, which generates a number. The EMV chip generates a new number for every transaction. The new number specifies the user's payment account. More specifically, the chip and payment module 114 work together to create a unique, encrypted code, called a token or cryptogram. This token is unique to the specific transaction taking place and will only be used that one time. This number is created from information in the chip combined with information in payment module 114, but using instructions contained only in the chip. That number may be combined with a PIN entered on tablet computing device 104 or the user's mobile device (not shown) in wireless communication with tablet computing device 104 or payment module 114. The PIN may be checked to determine whether it matches to a PIN stored on the card to ensure a greater level of user authentication. Alternatively or additionally, a user may provide a signature using a touch screen on the tablet computing device 104 or the user's mobile device (not shown) in wireless communication with tablet computing device 104 or payment module 114.

In addition to card insert 112, payment module 114 has a near-field communication (NFC) reader 110 that allows for collection of payment data. NFC reader 110 may allow for collection of payment data from an EMV chip or from a user's mobile device (not shown). In an example operation, the NFC reader 110 may communicate with software or hardware on the user's mobile device in a manner similar to how it can communicate with the EMV chip. In another example, the user's mobile device uses a virtual credit card number, which the mobile payment provider's servers verify, and then send the user's real credit card number to a merchant or payment gateway to complete the transaction.

As mentioned above, payment module 114 transmits the collected and encrypted payment data for processing at a payment gateway. The payment gateway is a merchant service provided that authorizes credit card or direct payments processing for e-businesses, online retailers, bricks and clicks, or traditional brick and mortar. The payment gateway may be provided by a bank to its customers, but can be provided by a specialized financial service provider as a separate service, such as a payment service provider. Payment module 114 may transmit the payment data to tablet computing device 104, which transmits the information directly to the payment gateway. Alternatively or additionally, tablet computing device 104 may transmit the payment data to a merchant, which forwards the information to the payment gateway to process the payment.

To process the payment, the payment gateway decrypts and decodes the payment information. In an example, the payment gateway may decode the received token to verify that it came from your card's chip. To do this, payment gateway may send the token to the card issuer.

As mentioned above, payment module 114 is incorporated into kiosk mounting apparatus 102. More specifically, payment module 114 is located within an enclosure 118 of kiosk mounting apparatus 102. Having payment module 114 enclosed within kiosk mounting apparatus 102 in this way may be aesthetically pleasing. Also, it may be less bulky and more durable than having the payment device be external, perhaps hanging off the side of a tablet. At the same time, kiosk mounting apparatus 102 is also configured to enable use of a commercially available tablet, making it more cost-effective than an entirely custom-built kiosk device.

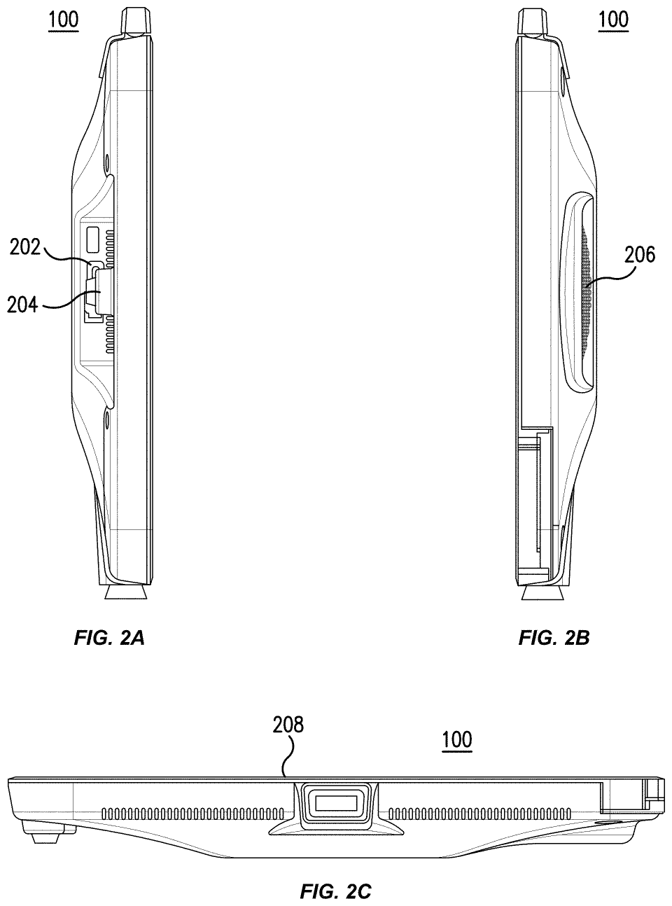

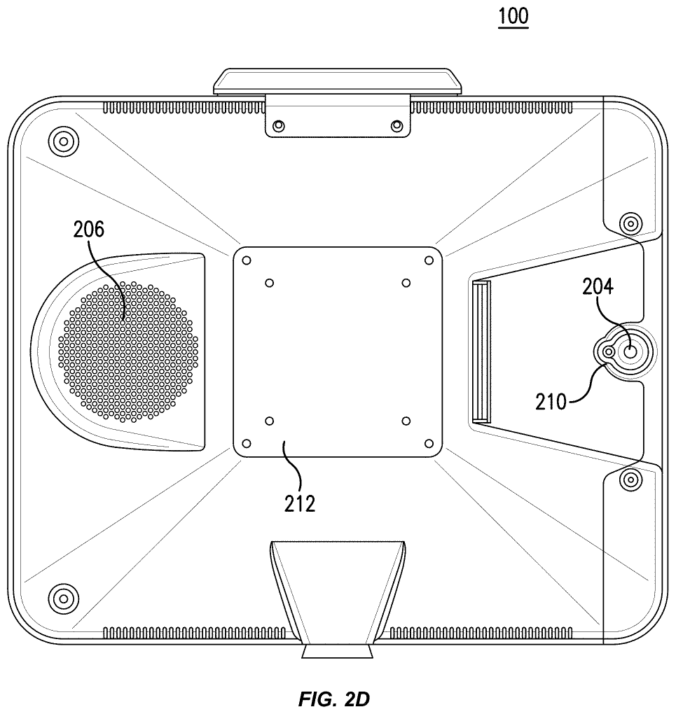

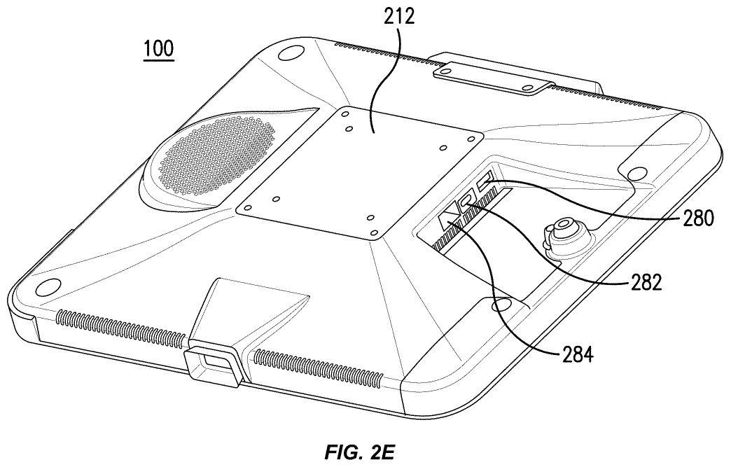

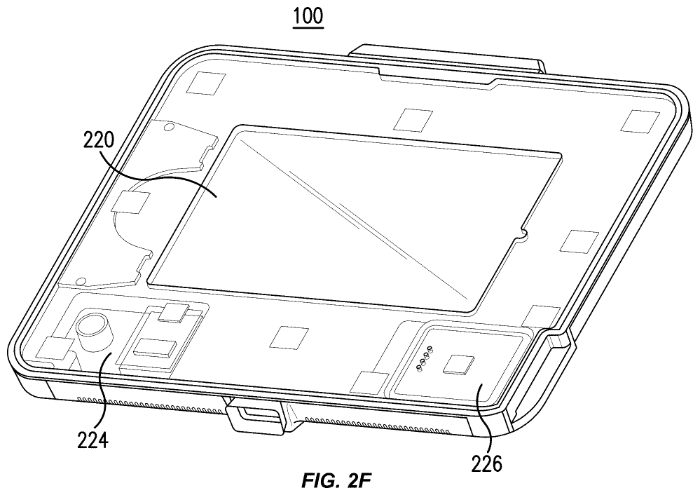

Enclosure 118 is mounted to the chassis (as illustrated below with respect to FIG. 2G). Enclosure 118 has an opening for the touch screen display and encloses the payment module.

Enclosure 118 is a container, a protective exterior (e.g. shell) designed to enable easier handling and perhaps provide attachment points for internal mechanisms (e.g. mounting brackets for electrical components) of kiosk 100. Enclosure 118 may be configured to maintain cleanliness of the contents of enclosure 118 by shielding them dirt/dust, fouling and other contaminations. Enclosure 118 may also protect interior mechanisms (e.g., electrical fittings) from structural stress and/or potential physical, thermal, or water damage from the surrounding environment.

Enclosure 118 also contains a radio-frequency identification (RFID) reader 116. RFID reader 116 is located within enclosure 118 and is configured to read an RFID tag and input data read from the RFID tag to the tablet computing device. Radio-frequency identification uses electromagnetic fields to automatically identify and track tags attached to objects. An RFID system consists of a tiny radio transponder, a radio receiver and transmitter. When triggered by an electromagnetic interrogation pulse from RFID reader 116, an RFID tag transmits digital data back to the reader.

RFID reader 116 can be used for a variety of scenarios including for point of job sale check out, access management (e.g. where an ID badge includes an RFID tag), reading passports, tracking hospital equipment, tracking library items, or otherwise tracking inventory.

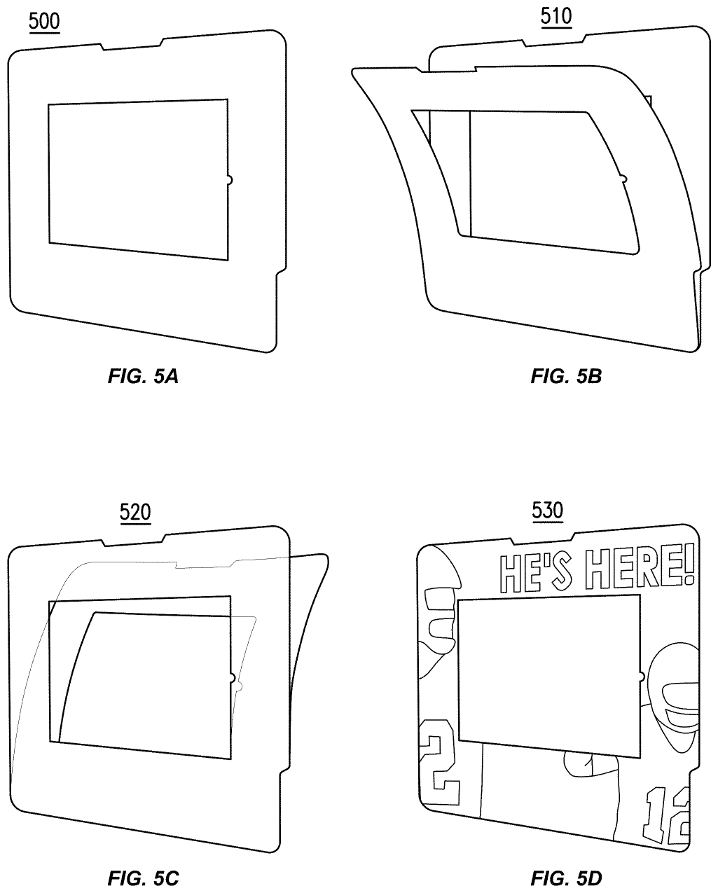

Attached to a front face of enclosure 118 is interchangeable faceplate 108. Interchangeable faceplate 108 allows for custom graphics to be applied to the front face of kiosk 100. In this way, interchangeable faceplate 108 can be used to apply custom branding and design to kiosk 100. Interchangeable faceplate 108 is discussed in greater detail with respect to FIGS. 5A-D.

Kiosk mounting apparatus 102 also includes a light source 106. Light source 106 is configured to illuminate when a signal is received from tablet computing device 104. In this way, light source 106 can be used by an application running on tablet computing device 104 to notify a user when a particular action needs to be taken. In an example, light source 106 may be a string of light-emitting diode (LED) lights.

FIG. 2A illustrates kiosk 100 from a left-side view. As shown from this perspective, kiosk 100 and in particular kiosk mounting apparatus 102 includes a quick release lock 204 and wired interfaces 202.

Quick release lock 204 allows the kiosk to be securely locked in-place for example to a wall or mounting arm as is illustrated with respect to FIGS. 2A and B. Quick release lock 204 may enable kiosk mounting apparatus 102 and tablet computing device 104 to be removed from the wall or mounting arm, while deterring theft of kiosk mounting apparatus 102 and tablet computing device 104.

Wired interfaces 202 electrically couple supply power to tablet computing device 104. As will be discussed below, wired interfaces 202 can include Ethernet and USB connections that provide not only power but also data input and output from tablet computing device 104 and the various peripheral devices within and connected to kiosk mounting apparatus 102.

FIG. 2B illustrates kiosk 100 from a right-side view. As can be seen from this perspective, kiosk 100, in particular kiosk mounting apparatus 102, includes an optional active cooling device 206.

Active cooling device 206 is configured to actively disperse heat generated by tablet computing device 104, and possibly other peripheral devices included within kiosk mounting apparatus 102, such as payment module 114. Active cooling device 206 may be a fan or other mechanism, such as an air conditioner heat pump, to actively disperse heat away from tablet computing device 104. Doing so may increase the operating life of tablet computing device 104. Alternatively or additionally, passive cooling components such as a heat sink may be used to disperse heat away from tablet computing device 104.

FIG. 2C illustrates kiosk 100 from a bottom view. As can be seen from this perspective, kiosk 100, in particular kiosk mounting apparatus 102, includes a barcode scanner 208.

Barcode scanner 208 is an optical scanner that can read printed optical labels such as barcodes, decode the data contained in the optical label, and send the data to a tablet computing device 104. It may include a light source, a lens, and a light sensor translating for optical impulses into electrical signals. In different embodiments, optical detector 210 can be a pen-type reader, a laser scanner, a charge-coupled device (CCD) reader, a light emitting diode (LED) scanner, a camera-based reader, a video camera reader, a large field-of-view reader, or an omnidirectional barcode scanner. Barcode scanner 208 may read a linear dimensional (1D), one-dimensional barcode or a two-dimensional barcode that uses rectangles, dots, hexagons and other patterns to visually encode information.

FIG. 2D illustrates kiosk 100 from a rear view. As can be seen from this perspective, kiosk 100, in particular kiosk mounting apparatus 102, includes a VESA mount 212 and security lock screw 210.

Video Electronics Standards Association (VESA) mount 212 is a standard for mounting flat panel monitors. It is also known as the Flat Display Mounting Interface (FDMI) or the VESA Mounting Interface Standard (MIS). It may have four screw-holes arranged in substantially a square.

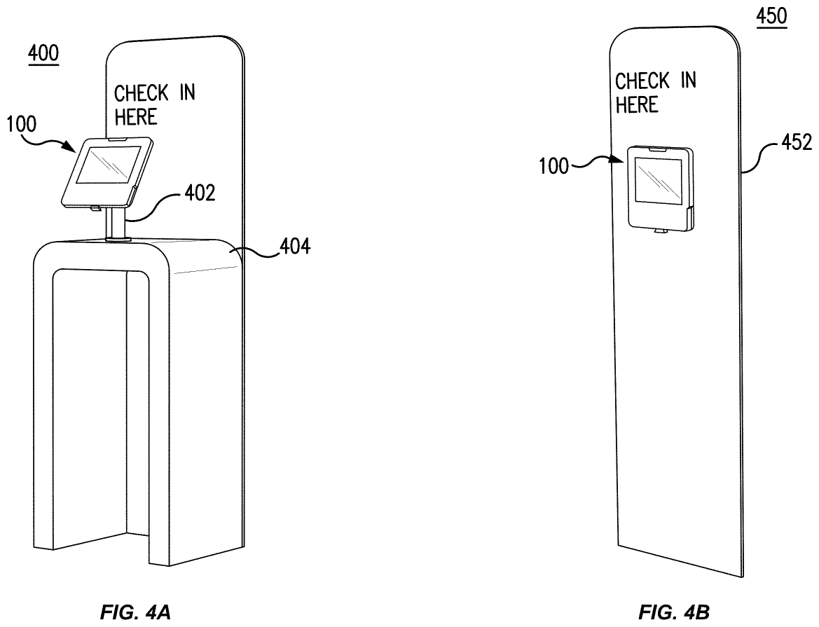

Security lock screw 210 locks a tether or other coupling to quick release lock 204. It may need a special thread or key to unscrew. In this way, security lock screw 204 secures kiosk mounting apparatus 102 to a wall or mounting arm (as will be described below with respect to FIGS. 4A and B), and prevents theft or tampering of kiosk 100 and its components.

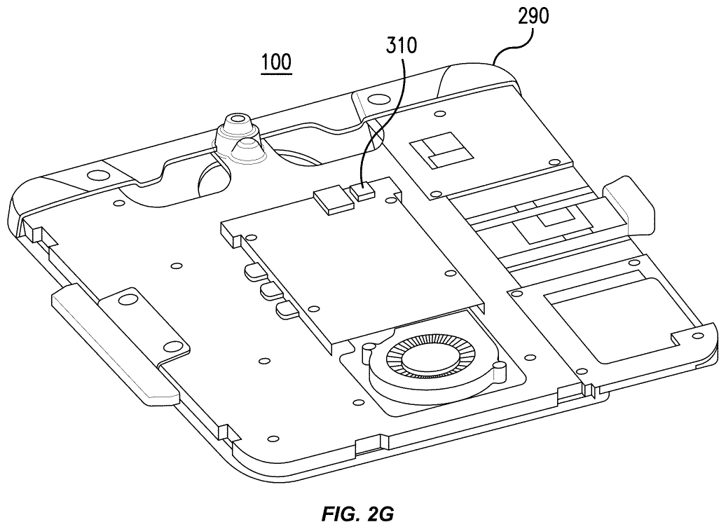

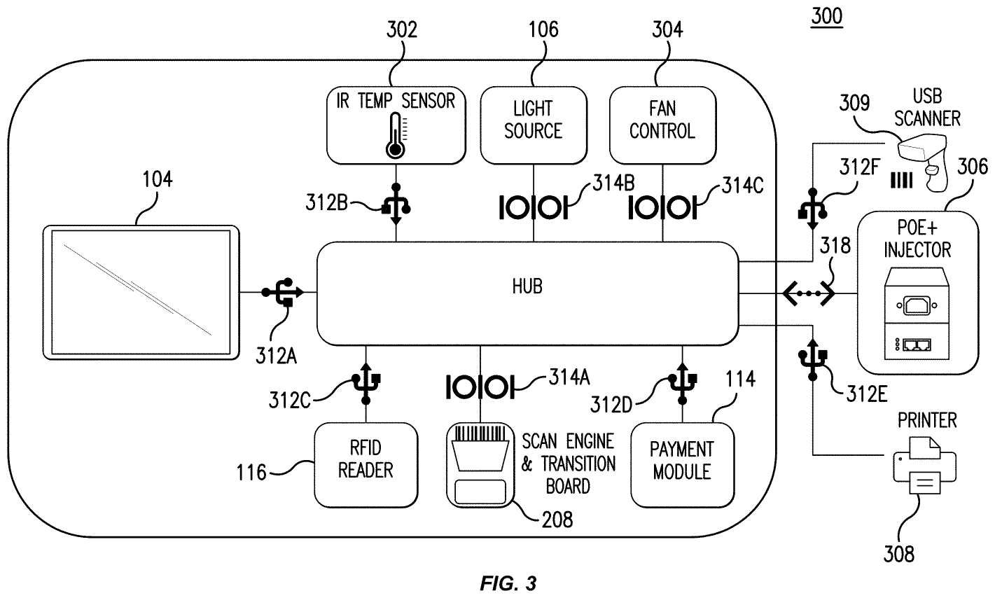

FIG. 2E illustrates kiosk 100 from a left-rear three-quarters view. As can be seen from this perspective, kiosk 100, in particular kiosk mounting apparatus 102, includes various wired interfaces 202, including a Universal Serial Bus (USB) external peripheral interface 280, USB power input 282, and Ethernet port 284. Each of these connections is described briefly below and in greater detail with respect to FIG. 3.

USB external peripheral interface 280 may communicatively couple tablet computing device 104 to external peripherals, such as an external scanner or printer. In an example, USB external peripheral interface 280 may be a USB Type A receptacle.

USB power input 282 may electrically couple to tablet computing device 104, supplying power to tablet computing device 104. In an example, USB power input 282 may be a USB Type C, having a 24-pin USB, rotationally symmetrical connector.

Ethernet port 284 may both electrically and communicatively couple to tablet computing device 104. It may connect to a twisted pair cable with an 8P8C plug to couple on a physical layer with a local area network, which may connect to a wide area network. In this way, ethernet port 284 may enable tablet computing device 104, which may have built-in wireless network capability, to access a wired local network, which may be more reliable and have fewer dead zones. In addition, as discussed in greater detail below with respect to FIG. 3, ethernet port 284 may supply power to tablet computing device 104, avoiding a need to couple kiosk 100 to USB power input 282.

FIG. 2F illustrates kiosk 100 from a cutaway right-front three-quarters view. As can be seen from this perspective, kiosk 100, in particular kiosk mounting apparatus 102, includes an opening 220 and peripheral cavities 224 and 226.

Opening 220 is for tablet computing device 104's touch screen display. Opening 220 may simply open up enclosure 118 for the touch screen display. Alternatively, opening 220 may be a transparent window material that still allows a user to make selections on the touch screen display

Peripheral cavities 224 and 226 provide locations for RFID reader 116 and payment module 114 respectively. In additional embodiments, the internal peripherals in the slots may be interchangeable, allowing further customization of kiosk 100.

FIG. 2G illustrates kiosk 100 from a cutaway rear view. As can be seen from this perspective, kiosk 100, in particular kiosk mounting apparatus 102, includes a chassis 290 and hub 310.

Chassis 290 is configured to mount tablet computing device 104. Chassis 290 represents a structural framework for various internal components of kiosk 100. For example, chassis 290 may provide structural framework to position internal peripheral devices, such as RFID reader 116, payment module 114, barcode scanner 208, and active cooling device 206. Chassis 290 may also be fixed into or include VESA mount 212. In an example, chassis 290 may be an anodized aluminum frame structure.

Hub 310 is located within enclosure 118 and configured to communicatively and electrically couple with tablet computing device 104 internal and external peripheral devices as illustrated in FIG. 3.

FIG. 3 is a circuit diagram 300 of a kiosk, according to an embodiment of the invention. As illustrated in circuit diagram 300, hub 310 includes USB ports 312A-F, serial ports 314A-C, and Ethernet port 318. In an embodiment, hub 310 is configured to communicatively and/or electrically couple various devices connected on these ports, enabling them to transfer data to one another and/or to supply power.

USB ports 312A-F are USB ports, each configured to communicatively and/or electrically couple a peripheral device with the tablet computing device. USB ports 312A-D enables connection to internal peripheral devices and USB ports 312E-F enables connection to external peripheral devices. USB port 312A connects hub 310 to tablet computing device 104, enabling communication between (both to and from) tablet computing device 104 and the various devices connected to hub 310 and supplying power to tablet computing device 104. USB port 312B connects hub 310 to a temperature sensor 302, enabling communication between (both to and from) temperature sensor 302 and the various devices connected to hub 310 and supplying power to temperature sensor 302. USB port 312C connects hub 310 to RFID reader 116, enabling communication between (both to and from) RFID reader 116 and the various devices connected to hub 310 and supplying power to RFID reader 116. USB port 312D connects hub 310 to payment module 114, enabling communication between (both to and from) payment module 114 and the various devices connected to hub 310 and supplying power to payment module 114. USB port 312E connects hub 310 to a printer 308, enabling communication between (both to and from) printer 308 and the various devices connected to hub 310 and supplying power to printer 308. USB port 312F connects hub 310 to an external scanner 309, enabling communication between (both to and from) external scanner 309 and the various devices connected to hub 310 and supplying power to external scanner 309.

Serial ports 314A-C are configured to interface with a serial port device, that is, a device requiring a serial port interface. Serial port 314A-C may be COM ports, for example using a DE-9 connector. Serial port 314A connects to barcode scanner 208 enabling communication between (both to and from) barcode scanner 208 and the various devices connected to hub 310. Serial port 314B connects to light source 106 enabling communication between (both to and from) light source 106 and the various devices connected to hub 310. Serial port 314C connects to fan control 304 enabling communication between (both to and from) fan control 304 and the various devices connected to hub 310.

Ethernet port 318 provides an external Ethernet connection, as described above, to allow connection to a network and supply power to hub 310 and the devices connected to hub 310. Ethernet port 318 may be connected to Ethernet adapter 306. Ethernet adapter 306 may be a PoE+ injector. A PoE+ injector supplies power and data via one single Ethernet cable to hub 310 devices. In this way, the PoE+ injector allows kiosk 100 to be positioned in a location with no power lines or outlets.

Temperature sensor 302 is a digital thermometer that senses the ambient temperature within kiosk mounting apparatus 102 and communicates the ambient temperature to fan control 304. In an example, temperature sensor 302 may include an infrared thermometer.

Fan control 304 controls active cooling device 206. In particular, fan control 304 may activate active cooling device 206 when temperature sensor 302 signals that ambient temperature within kiosk mounting apparatus 102 exceeds a desired range for tablet computing device 104.

External scanner 309 is a barcode scanner as described above with respect barcode scanner 208. Being external, scanner 309 may make it easier to scan devices that are bulky or have an awkward shape.

Printer 308 is a device that makes a persistent representation of graphics or text, usually on paper. Printer 308 may be used by tablet computing device 104 to, for example, print receipts.

FIGS. 4A-B illustrate different ways for the kiosk to be mounted.

As shown in a diagram 400 in FIG. 4A, kiosk 100 may be mounted on mounting arm 402, which angles kiosk 100 at a desirable angle to face the user and acts as a stand on a table 404. In an alternative embodiment, mounting arm 402 may extend all the way to the floor, avoiding the need to rest kiosk.

In a further alternative embodiment, kiosk 100 may be mounted flush against a wall as illustrated in a diagram 450 in FIG. 4B. As illustrated in diagram 450, kiosk 100 is mounted flush and parallel with a wall backing 452.

FIGS. 5A-D illustrate different ways of attaching graphics to a front face of kiosk mounting apparatus 102.

FIG. 5A illustrates a diagram 500 showing graphics attached using screen-printing. Screen-printing may involve using a mesh to transfer ink onto a substrate (in this case the front face of kiosk mounting apparatus 102). A blade or squeegee may be moved across the screen to fill the open mesh apertures with ink, and a reverse stroke may then causes the screen to touch the substrate momentarily along a line of contact, imparting graphics onto the front face of kiosk mounting apparatus 102. A stencil may be used to limit where ink is applied to the front face.

FIG. 5B illustrates a diagram 510 showing graphics attached using a vinyl-on-substrate technique. With this technique, screen-printing may be used to print graphics on top of a vinyl substrate. The unprinted side of the substrate is then attached to a front face of the kiosk mounting device 102. Using a separate vinyl substrate may provide interchangeability as well as durability, longevity, and flexibility.

FIG. 5C illustrates a diagram 520 showing graphics attached using a vinyl-behind-substrate technique. Similar to the vinyl-on-substrate technique, screen-printing may be used to print graphics on a vinyl substrate. Here, the vinyl substrate may be transparent and the printed side may be affixed to the front face of the kiosk mounting device 102.

FIG. 5D illustrates a diagram 530 showing graphics attached using an in-mold laminate technique. The in-mold lamination involves injecting the backside detail of a mold underneath the finished product, in this case the front face of the kiosk mounting device 102.

FIG. 6 illustrates a system diagram of the tablet computing device 104. Tablet computing device 104 may be a commercially available tablet device such as those running the Android operating system and available from Samsung Inc. Tablet computing device 104 includes various components connected by a bus 624, including a processor 602, memory 604, touchscreen display 608, USB interface 610, wireless network interface 612, camera 614, microphone 616, speaker 618, and location sensors 620.

Processor 602 is adapted to run instructions stored in memory 604. Processor 602 may be a micro-controller unit (MCU), a digital signal processor (DSP), and/or an Image/Video Processing unit or the like components that run instructions. An example of an MCU is MSP432P401x, available from Texas Instruments Incorporated of Dallas, Tex. An example of a DSP is C5000, also available from Texas Instruments. An example of an image/video processor is OMAP3525, also available from Texas Instruments. One or more processors 602 may be present. Processor 602 may be an independent component; it may also be embedded in another component.

Memory 604 may include random access memory (RAM) and may also include nonvolatile memory, such as read-only memory (ROM) and/or flash memory. Memory 604 may be embodied as an independent memory component, and may also be embedded in another component, such as processor 602, or may be embodied as a combination of independent as well as embedded, and/or a plurality of memory components is present.

Interactive application 606 is software to carry out a specific task other than one relating to the operation of the computing device itself, typically to be used by end-users. In one example, interactive application 606 may be a web browser. Interactive application 606 may also enable contactless control by a user as described in U.S. patent application Ser. No. 17/011,458, incorporated by reference herein in its entirety.

Touchscreen display 608 is an input/output device. It is an assembly of both an input (touch panel) and output (display) device. Display 608 outputs data by presenting information in visual form. It outputs information that is supplied to it from a computing device (not shown) in ring scanner device, converting electrical signals into light. In different examples, touchscreen display 608 can be an electroluminescent (ELD) display, liquid crystal display (LCD), light-emitting diode (LED) backlit LCD, thin-film transistor (TFT) LCD, light-emitting diode (LED) display, OLED display, AMOLED display, plasma (PDP) display, or quantum dot (QLED) display. The touch panel may be layered on the top of the output electronic visual display. A user can give input or control through simple or multi-touch gestures by touching the screen with a special stylus or one or more fingers. In different examples, a touch panel may be a resistive touchscreen panel, a surface acoustic wave (SAW) touch panel, a capacitive touchscreen panel, or an infrared touchscreen panel.

USB interface 610 is a USB interface to connect to hub 310, as described above.

Wireless network interface 612 is adapted to attach to a wired network, including, but not limited to, Ethernet, USB, or thunderbolt.

Camera 614 captures image data by capturing light, generally through one or more lenses. Camera 614 includes an image sensor (not shown). The image sensor may, for example, be a charge coupled device (CCD) sensor or a complementary metal oxide semiconductor (CMOS) sensor.

Microphone 616 converts sound into an electrical signal. Microphone 616 is positioned to capture speech of a user of tablet computing device 104. In different examples, microphone 616 could be a condenser microphone, electret microphone, moving-coil microphone, ribbon microphone, carbon microphone, piezo microphone, fiber-optic microphone, laser microphone, water microphone, or MEMS microphone.

Speaker 618 is configured to emit sound as specified by commands from processor 602. Example speakers includes moving-iron loudspeakers, piezoelectric speakers, magnetostatic loudspeakers, electrostatic loudspeakers, ribbon and planar magnetic loudspeakers, bending wave loudspeakers, flat panel loudspeakers, Heil air motion transducers, transparent ionic conduction speakers, plasma arc speakers, thermoacoustic speakers, rotary woofers, moving-coil, electrostatic, electret, planar magnetic, and balanced armature.

Location sensors 620 may be a GPS sensor, accelerometer, gyroscope, network location sensor, or any combination thereof.

Bus 624 is a communication system that transfers data between the hardware components of tablet computing device 104. In addition to transferring data, bus 624 may also transfer electrical power, such as from a battery (not shown) of tablet computing device 104 to other components. In this way, bus 624 communicatively and electrically couples the various components together.

It may be appreciated for those skilled in the art that a plurality of signal lines or buses 624 may exist, thus different components may be linked by different signal lines or buses 624, and that a signal line or buses 624 depicted in the schematic diagram may represent a plurality of such.

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications, such as specific embodiments, without undue experimentation, and without departing from the general concept of the present invention. Therefore, such adaptations and modifications are intended to be within the meaning and range of equivalents of the disclosed embodiments based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A kiosk mounting apparatus, comprising:
a chassis of the kiosk mounting apparatus configured to mount a tablet computing device to a kiosk, wherein the tablet computing device is embedded within a cavity of an enclosure of the kiosk mounting apparatus, and wherein the tablet computing device has a touch screen display and is configured to execute an interactive application;
a payment module, incorporated into the enclosure and separate from the tablet computing device, and configured to be communicatively coupled to the tablet computing device, wherein the payment module is configured to (i) detect payment data specifying an account from a user's payment device, (ii) encrypt the payment data, and (iii) communicate the encrypted payment information to the tablet computing device for processing by a payment gateway; and
wherein the enclosure is mounted to the chassis and has an opening for the touch screen display.

2. The kiosk mounting apparatus of claim 1, comprising:
a wired networking terminal configured to communicatively couple the tablet computing device with a wired network connection.

3. The kiosk mounting apparatus of claim 1, wherein the wired networking terminal is configured to electrically couple the tablet computing device to supply power to the tablet computing device.

4. The kiosk mounting apparatus of claim 1, wherein the wired networking terminal is an Ethernet terminal.

5. The kiosk mounting apparatus of claim 1, the enclosure comprising:
a front face configured to accept removable graphics.

6. The kiosk mounting apparatus of claim 5, wherein the front face is configured to accept graphics using at least one of: screen printing, vinyl on substrate, vinyl behind substrate, and in-mold laminate.

7. The kiosk mounting apparatus of claim 1, comprising:
a Video Electronics Standards Association (VESA) mount affixed to the enclosure.

8. The kiosk mounting apparatus of claim 1, comprising:
a Universal Serial Bus (USB) hub located within the enclosure and configured to communicatively and electrically couple with the tablet computing device.

9. The kiosk mounting apparatus of claim 1, the kiosk mounting apparatus further comprising a serial port device located within the enclosure, and wherein the USB hub comprises:
a USB port configured to interface with the tablet computing device,
a serial port, communicatively coupled to the USB port, configured to interface with the serial port device.

10. The kiosk mounting apparatus of claim 1, comprising:
a radio frequency ID (RFID) reader, located within the enclosure, configured to read an RFID tag and input data read from the RFID tag to the tablet computing device.

11. The kiosk mounting apparatus of claim 1, comprising:
a barcode reader, at least partially located within the enclosure, configured to read a barcode and input data read from the barcode to the tablet computing device.

12. The kiosk mounting apparatus of claim 1, wherein the payment module is configured to receive a personal identification number and combine the personal identification number with the payment data to create a payment token to communicate to the payment gateway.

13. The kiosk mounting apparatus of claim 1, further comprising:
a light source configured to illuminate when a signal is received from the tablet computing device.

14. The kiosk mounting apparatus of claim 1, further comprising:
an active cooling device configured to actively disperse heat generated by the tablet computing device.

15. A kiosk, comprising:
a tablet computing device;
a chassis of a kiosk mounting apparatus configured to mount the tablet computing device to the kiosk, wherein the tablet computing device is embedded within a cavity of an enclosure of the kiosk mounting apparatus, and wherein the tablet computing device has a touch screen display and is configured to execute an interactive application;
a payment module, incorporated into the enclosure and separate from the tablet computing device, and configured to be communicatively coupled to the tablet computing device, wherein the payment module is configured to (i) wirelessly detect payment data specifying an account from a user's payment device, (ii) encrypt the payment data, and (iii) communicate the encrypted payment information to the tablet computing device for processing by a payment gateway; and
wherein the enclosure is mounted to the chassis and has an opening for the touch screen display.

16. The kiosk of claim 15, comprising:
a wired networking terminal configured to communicatively couple the tablet computing device with a wired network connection.

17. The kiosk of claim 15, wherein the wired networking terminal is configured to electrically couple the tablet computing device to supply power to the tablet computing device.

18. The kiosk of claim 15, wherein the wired networking terminal is an Ethernet terminal.

19. The kiosk of claim 15, comprising:
a Video Electronics Standards Association (VESA) mount affixed to the enclosure.

20. A tablet computing device, comprising:
a processor;
a touch screen display;
a tangible, non-transitory memory, coupled to the processor, including instructions thereon instructing the processor to signal a payment module to process a payment, the payment module incorporated into an enclosure of a kiosk mounting apparatus and separate from the tablet computing device, the payment module being configured to, in response to the signal, (i) wirelessly detect payment data specifying an account from a user's payment device, (ii) encrypt the payment data, and (iii) communicate the encrypted payment information to the tablet computing device for processing by a payment gateway; and
a USB interface communicatively and electrically coupled to the processor.

21. The kiosk mounting apparatus of claim 1, wherein the payment module is coplanar with the tablet computing device.
